(19) United States
(12) Patent Application Publication
(10) Pub. No.: US 2011/0128566 A1
(43) Pub. Date: Jun. 2, 2011

(54) IMAGE FORMING APPARATUS, HOST APPARATUS, AND SECURITY COPY METHOD THEREOF

(75) Inventors: Ju-ho EUM, Anyang-si (KR); Ki-young Shin, Namyangju-si (KR)

(73) Assignee: Samsung Electronics Co., Ltd, Suwon-si (KR)

(21) Appl. No.: 12/956,287

(22) Filed: Nov. 30, 2010

(30) Foreign Application Priority Data
Dec. 1, 2009 (KR) 10-2009-117922

(51) Int. Cl. G06K 15/00; G06F 17/00

(52) U.S. Cl. 358/1.14; 235/375

(57) ABSTRACT

A security copy method of an image forming apparatus includes generating scan data by scanning a document including predetermined additional information, determining whether to security-print the document by using the additional information of the generated scan data, determining whether the scan data include color information corresponding to the security area, and printing the scan data excluding a security area corresponding to the color information from the scan data according to the determination result. With this, the image forming apparatus minimizes the amount of the security information included in a bar code or mark and enables a simple print process.

### CROSS-REFERENCE TO RELATED APPLICATIONS

This application claims the benefit of priority under Korean Patent Application No. 10-2009-0117922, filed on Dec. 1, 2009 in the Korean Intellectual Property Office, the disclosure of which is incorporated herein by reference in its entirety.

### BACKGROUND

1. Field of the Invention

Apparatuses and methods consistent with the exemplary embodiments relate to an image forming apparatus, a host apparatus, and a print method thereof, and more particularly, to an image forming apparatus, a host apparatus, and a security copy method thereof which performs a security copy operation by using additional information in a document which has a security area therein.

2. Description of the Related Art

An image forming apparatus forms an image on a document. The image forming apparatus may include a printer, a photocopier, a facsimile, a multi-function device which has at least two functions, etc.

Recently, demand for an image forming apparatus as an office automation device performing not only a document print function but also a scanning function and a faxing function has increased. Accordingly, the image forming apparatus has been developed to provide extended functions with high performance.

The image forming apparatus may have a security copy function to prevent the image forming apparatus from printing or copying a security document that includes confidential or restricted information.

In a conventional security print method, when the image forming apparatus recognizes the security document, the image forming apparatus does not print the document at all or does not process input information when the document is scanned to be copied.

In addition, according to another security print method, a user may insert a bar code including security information into a security document.

The security print method using the bar code may be performed by: (i) not printing a document when a barcode is detected on the document, (ii) adding a preset particular pattern to the entire document and deteriorating readability of the document, and (iii) recognizing and not processing a text subject to security when the document is scanned to be copied.

However, in using the methods above like not printing the entire document or adding the particular pattern, all other information in the document as well as the security part is not provided and this causes inconvenience.

Also, the method of recognizing and not processing the text subject to security may require an additional process such as optical character recognition (OCR). The larger number of security targets deteriorates the overall performance of the system due to the bar code reading process.

Further, as the security targets increase, the bar code may not have the data capacity to include all of the security information.

### SUMMARY

Accordingly, one or more exemplary embodiments provide an image forming apparatus, a host apparatus, and a print method thereof which prints a document excluding an image in a security color by using preset additional information including security color information in security-copying the document having a security area therein to thereby minimize the amount of the security information included in the additional information and provide a simple printing process.

Additional features and utilities of the present general inventive concept will be set forth in part in the description which follows and, in part, will be obvious from the description, or may be learned by practice of the general inventive concept.

Another exemplary embodiment may include an image forming apparatus, a host apparatus and a print method thereof which prints a document including additional information with security color information by changing a text or an image corresponding to security information input by a user into a predetermined security color to conveniently generate a security document.

The foregoing features and/or utilities may be achieved by providing a security copy method of an image forming apparatus which is connected to at least one external device and includes an image scanner to scan a document including a security area, the method including generating scan data by scanning the document including predetermined additional information, determining whether to security-print the document by using the additional information of the generated scan data, determining whether the scan data include color information corresponding to the security area, and printing the scan data excluding a security area corresponding to the color information from the scan data according to the determination result. The color information may include at least one of cyan (C), magenta (M) and yellow (Y).

The predetermined additional information may include at least a 1-D bar code or mark.

The method may further include generating a document including the predetermined additional information, and the additional information may include color information corresponding to the security area.

The generating the document may include generating the document by using an application from at least one external device.

The determining whether to security-print the document may include detecting a bar code or mark area of the generated scan data, reading the detected bar code or mark area information, and determining whether the read bar code or mark information includes color information corresponding to the security area.

The method may further include receiving a copy command with respect to the document including the predetermined additional information.

The method may further include inputting text or image information included in the security area and security color information corresponding to the security area.

The method may further include converting a target document into a bitmap image according to a print command and searching a text or image included in the security area from the converted bitmap image and converting the text or image into the security color.

The method may further include converting the input security color information into at least a 1-D bar code or mark.

Features and/or utilities of the present general inventive concept may also be achieved by providing an image forming apparatus which performs a security copy function by using a security color of a document, the image forming apparatus including an image forming unit which performs a print operation, an image scanner which scans a document including a security area, and a controller which controls the image scanner to scan the document including predetermined additional information and to generate scan data, determines whether to security-print the document by using additional information of the generated scan data, determines whether the scan data include security information corresponding to the security area, and controls the image forming unit to print the scan data excluding a security area corresponding to the color information from the scan data according to the determination result. The color information may include at least one of cyan (C), magenta (M) and yellow (Y).

The predetermined additional information may include at least a 1-D bar code or mark.

The controller may detect a bar code or mark area of the generated scan data and may read the detected bar code or mark area and determine whether the read bar code or mark information includes color information corresponding to the security area.

The image forming apparatus may further include a user input unit which receives a copy command with respect to a document including the predetermined additional information.

Features and/or utilities of the present general inventive concept may also be achieved by providing a host apparatus which is connected to at least one image forming apparatus and which generates print data including security color information, the host apparatus including a communication unit which communicates with the image forming apparatus, an image processor which generates print data including a security area, a user input unit which receives text or image information included in the security area and security color information corresponding to the security area, and a controller which controls the image processor to generate print data including at least a 1-D bar code or mark corresponding to the input security color information and controls the communication unit to transmit the generated print data to the image forming apparatus.

The user input unit may receive a print command, and the controller may control the image processor to convert a target document into a bitmap image according to the print command and search a text or image included in the security area from the converted bitmap image and generate print data converted into the security color.

The controller may control the image processor to convert the input security color information into the 1-D bar code or mark.

Features and/or utilities of the present general inventive concept may also include a method of generating a secure document, the method including receiving an input to select first data of a document as restricted data, associating the first data with a security color, generating a security code on the document to include the security color, and transmitting the document including the security code to an image forming apparatus.

Receiving an input to select the first data may include receiving an input from a user.

Receiving an input to select the first data may include receiving an instruction to select each data anywhere in the document having a predetermined characteristic as restricted data.

Associating the first data with the security color may include selecting a security color and associating the first data with the selected security color.

Selecting the security color may include determining whether a first color is located in non-restricted data of the document, and if the first color is not located in the non-restricted data of the document, selecting the first color as the security color, and if the first color is located in the non-restricted data of the documents, selecting a second color different from the first color as the security color.

Selecting the security color may include receiving a user input to select the security color.

The method may further include determining whether the color selected by the user input is located in non-restricted data of the document, and if the color selected by the user is not located in the non-restricted data of the document, selecting the color as the security color, and if the color selected by the user is located in the non-restricted data of the documents, providing a notice to the user that the color selected by the user is located in the non-restricted data of the document.

The method may further include providing the user with at least one suggested color to select that is not located in non-restricted data of the document.

Associating the first data with the security color may include at least one of applying the first color to a font, underline, highlight, fill, and border of the first data.

Generating the security code on the document may include generating a barcode.

The barcode may include data regarding the security color.

The barcode further may include data regarding at least one of an operation to perform on the restricted data, a user to be allowed to perform an imaging operation to image the restricted data, and an imaging operation to reproduce the restricted data.

The barcode may include first data to perform a first security operation on the restricted data corresponding to a first user or a first imaging operation, and second data to perform a second security operation different from the first security operation on the restricted data corresponding to a second user or a second imaging operation.

Features and/or utilities of the present general inventive concept may also be realized by a method of copying a document including restricted data in an image copying apparatus, the method including determining whether restricted data exists in the document, identifying the restricted data in the document by detecting a security color associated with the restricted data, and performing a security operation on the restricted data when copying the document. Determining whether the restricted data exists may include detecting security data on the document.

The security data may include a barcode.

The method may further include determining the security color by analyzing the security data.

The security data may be formed of the security color.

The security data may be detected by performing optical scanning of the document.

Identifying the restricted data in the document may include detecting at least one of a font color, highlight color, fill color, and border color of the restricted data.

Performing the security operation may include at least one of omitting the restricted data from the printed document, blocking out the restricted data in the printed document, and distorting the printed data in the printed document.

Features and/or utilities of the present general inventive concept may also include a electronic document generating apparatus including a user input unit to receive an input to select first data in an electronic document as restricted data, an image processor to associate the restricted data in the electronic document with a security color and to generate security data in the document to instruct an imaging apparatus to perform a predetermined security operation on the restricted data indicated by the security color.

The electronic document generating apparatus may further include a communication unit to transmit the electronic document including the security data to an image forming apparatus.

The security data may include a barcode, and the image processor may process each of the barcode and the restricted data to be formatted in the security color.

The electronic document generating apparatus may further include a storage unit to store at least one predetermined security color.

Features and/or utilities of the present general inventive concept may also include an image forming apparatus including a scanning unit to scan a document, an image forming unit to form an image of the document onto a recording medium, and a controller to detect whether the document may include restricted data and to control the image forming unit to perform a security operation on the restricted data. The restricted data may be detected by detecting a security color.

The controller may detect whether security data exists on the document by controlling the scanning unit to search for the security data at a predetermined location on the document.

The controller may decode the security data to determine the security operation to perform on the restricted data.

The controller may decode the security data to determine the security color. The controller may detect a color of the security data to determine the security color.

The controller may determine whether data is restricted data by determining at least one of a font color, highlight color, fill color, and border color of the data.

### BRIEF DESCRIPTION OF THE DRAWINGS

The above and/or other features and utilities will become apparent and more readily appreciated from the following description of the exemplary embodiments, taken in conjunction with the accompanying drawings, in which:

FIG. 1 is a block diagram of an image forming apparatus and a host apparatus according to an exemplary embodiment of the present general inventive concept;

FIG. 2 illustrates scan data and a document which is printed by a security print according to the exemplary embodiment of the present general inventive concept;

FIG. 3 illustrates bitmap images before and after a change of print data according to the exemplary embodiment of the present general inventive concept;

FIG. 4 is a flowchart of a security copy process of a document which has a security area therein according to the exemplary embodiment of the present general inventive concept;

FIG. 5 is a flowchart of a process of generating a document which has a security area therein according to the exemplary embodiment of the present general inventive concept;

FIGS. 6A and 6B illustrate a method of generating a document including restricted information according to the present general inventive concept;

FIG. 7 illustrates a method of a user selection of restricted data according to an embodiment of the present general inventive concept; and

FIGS. 8A-8F illustrate examples of additional information or security data according to embodiments of the present general inventive concept.

### DETAILED DESCRIPTION OF THE EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

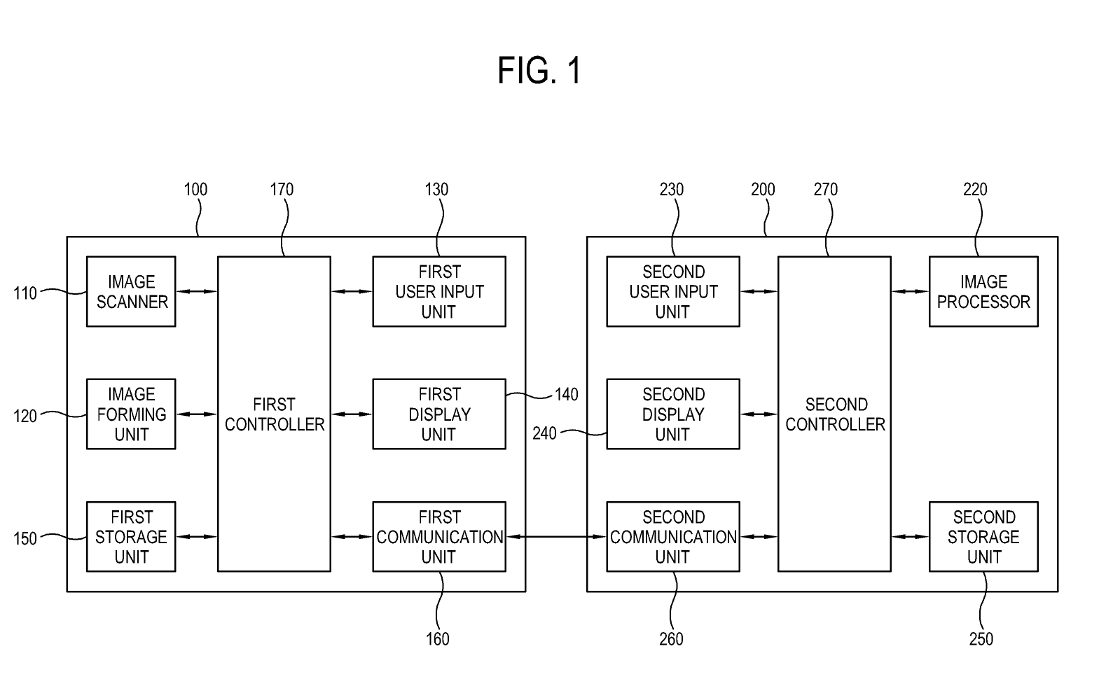

FIG. 1 is a block diagram of an image forming apparatus 100 and a host apparatus 200 according to an exemplary embodiment of the present general inventive concept. The image forming apparatus 100 according to the present general inventive concept may include a multi-function device having at least two functions out of printing, copying, scanning, and faxing functions or a printer.

The image forming apparatus 100 may scan an image from a target document, generate scan data, and print the document excluding a security area by using additional information of the scan data in copying the document including the additional information on whether to perform a security print operation and a security area corresponding to the additional information.

The image forming apparatus 100 may include an image scanner 110, an image forming unit 120, a first user input unit 130, a first display unit 140, a first storage unit 150, a first communication unit 160, and a first controller 170.

The image scanner 110 scans a target document and generates scan data. The target document may include a document, a photo, a film, etc. The image scanner 110 may include a photo converter such as CCD and CIS and an image processor which generates an image from a document by using a signal output from the photo converter. The image scanner 110 may further include a scan motor to drive the photo converter and the image processor and a guide.

The scan data which are scanned by the image scanner 110 may be changed into a fax signal and transmitted to an external fax machine by a fax unit (e.g. modem) (not shown) performing a fax communication.

The image scanner 110 may scan a document that includes a security area according to a copy command and may generate scan data including preset additional information. The security area is an area of the document that includes restrictions on copying, printing, or scanning. The generated scan data may include color information as the predetermined additional information corresponding to the security area. The predetermined additional information may include at least a one-dimensional (“1-D”) bar code or a mark.

If the predetermined additional information includes a bar code, the generated scan data may be security-printed, or printed to exclude the security area which is read by processes of detecting the bar code area, adjusting a bar code image, extracting particular information, and reading the bar code information.

The image forming unit 120 may form an image on at least one sheet of paper based on print data and may perform a print operation according to a print command. The print operation may include printing fax data, copying a scanned document, and printing data received from outside the image forming unit 120 through the host device 200 including a server, or print data stored inside the image forming apparatus 100, such as in a hard disk drive, or outside the image forming apparatus 100, such as in a USB memory stick.

The image forming unit 120 may print a document that includes the additional information such as a bar code or a mark including color information corresponding to the security area.

If the additional information includes a bar code, the bar code may be a one-dimensional (1-D) bar code or a multi-dimensional bar code, such as a 2-D bar code.

The 1-D bar code includes a combination of black bars and empty space between the bars, each of the bars and empty space having varying thicknesses to represent different characters or numbers. The 1-D bar code is read by absorption and reflection of light, and includes a standard type, GS1-13, S1-14 code, and GS1-128 code.

The 2-D bar code stores more information in a smaller space than the 1-D bar code. Graphic, photo, audio, fingerprint, signatures, as well as characters and numbers may be stored in the 2-D bar code. The 2-D bar code may be used to prevent forgery with encoding and video compressing technology. The 2-D bar code includes QR code, PDF417, Datamatrix, Maxicode, etc.

The first user input unit 130 receives a user's command. The first user input unit 130 may include an input button (“hard key”) provided in the image forming apparatus 100 or a graphic user interface (GUI) (“UI”) which is generated by an execution of a program such as an application and displayed on the first display unit 140 to receive a user's input by touch.

A user may perform a log-in process inputting an ID and a password assigned for each user account through the first user input unit 130. The log-in process includes an administrator log-in process in which setting and change of all of the environments of the image forming apparatus 100 is available without an additional access limit. If a user log-in or an administrator log-in process is performed, the image forming apparatus 100 identifies and permits a user. According to the present general inventive concept, a user includes an administrator.

The first display unit 140 displays thereon a setting and operation status of the image forming apparatus 100, and may display a UI screen to receive various commands from a user. The first display unit 140 may include a liquid crystal display (LCD), a driver (not shown) to drive the LCD, and a touch panel (“touch screen” or “touch pad”) to recognize a user's touch.

In the image forming apparatus 100, the first user input unit 130 may include an icon to be selected by a user through a touch panel of the first display unit 140. The first user input unit 130 and the first display unit 140 may be provided as a single unit or device rather than as separate units or devices.

When located in the same unit or device, the first user input unit 130 and the first display unit 140 may also be called an operation panel.

The first display unit 140 may include a local display unit which is provided in the image forming apparatus 100 and a remote display unit which is provided in the host apparatus 200 connected with the image forming apparatus 100 through the first communication unit 160.

If the first display unit 140 includes the remote display unit, a remote user interface is selected as the first user input unit 130 displayed on the remote display unit. A user's command is then received from the host apparatus 200 connected to the image forming apparatus 100 through the first communication unit 160.

The first storage unit 150 may store therein various print data for a print job, fax data for a fax transmission, image data scanned by the image scanner 110, data received from the outside connected through the first communication unit 160, various setting information of the image forming apparatus 100 through the first user input unit 130, user registration information set for each user account, user certification information, usage authorization information, etc.

The first storage unit 150 may include an internal storage medium such as an HDD, or an external or portable storage medium such as a USB memory, a memory card (memory stick, CF card, and a MMC), and a memory card slot.

The first communication unit 160 performs a data communication with the host apparatus 200 or another external device, such as a server connected in a wired/wireless network, and receives print data in a predetermined print language from the external device. The print data which are received from the host apparatus 200 may include a bar code.

The first communication unit 160 may include a wired/wireless network communication module which is connected with an external device such as the host apparatus 200 by a local connection or in a network by a predetermined protocol, or an interface (e.g., USB port) connected to a portable storage medium such as a USB memory or an interface which is connected to the HDD.

The image forming apparatus 100 may further include a fax communication module (e.g., modem) which converts image data generated by the image scanner 110 into a fax signal and transmits the fax signal to an external fax machine (including a multi-function device having a fax function) by using a public switched telephone network (PSTN) or receives a fax signal from the outside.

The first communication unit 160 may perform a scan-to-host function or a scan-to-server function to transmit a scanned image to the host apparatus 200 or an external device such as a server or perform a scan-to-email function to transmit a scanned image to the outside.

The data which are received from the outside through the first communication unit 160 (including fax data) are stored in the first storage unit 150.

The first controller 170 controls the image forming apparatus 100 as a whole.

More specifically, the first controller 170 controls the image scanner 110 to scan a document and generate scan data and stores the generated scan data in the first storage unit 150 upon reception of a copy command, i.e., hard copy command for the document including the security area and the predetermined additional information from the first user input unit 130.

The first controller 170 determines whether the scan data include the security area corresponding to the preset security color by using the additional information of the generated scan data and controls the image forming unit 120 to print the document excluding the security color image from the scan data according to the determination.

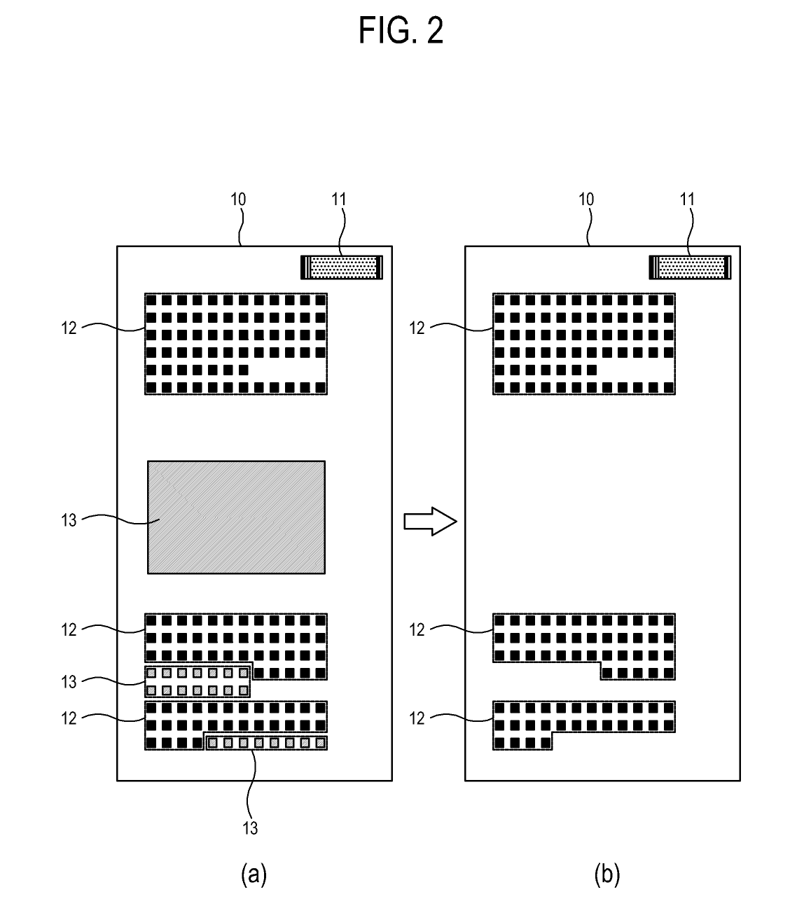

FIG. 2 illustrates scan data and a document printed in a security-mode printing operation according to an exemplary embodiment of the present general inventive concept.

Scan data 10 which are generated by the image scanner 110 corresponding to a copy command include an additional information area, or security information area, 11, a general or unsecured area 12, and a security area, or a restricted area, 13. As an example, FIG. 2 illustrates a bar code as the predetermined additional information.

The additional information area 11, or security data, includes a predetermined bar code image. The bar code may include one of a 1-D bar code and a multi-dimensional bar code which is at least 2-D. Alternatively, the additional information area or security information area 11 may be a color block, text, number, or any other symbol or means to store or represent data on a document.

The additional information 11 may be formed of the security color, and the data that the additional information represents may direct an image forming apparatus 100 what action to take with the security area 13. For example, if the security color is yellow, the image forming apparatus 100 may read a yellow barcode 11, and the data contained in the barcode may indicate to the image forming apparatus 100 whether to print, omit, or alter data in a security area 13 of a document 10 which may be identified by the same security color as the additional information.

Alternatively, the additional information 11 may be formed of a color different from the security color, and the data in the additional information 11 may indicate to the image forming apparatus 100 which color is the security color.

The general area 12 may not be subject to the security processing and may include non-restricted or non-confidential text and images.

The security area 13 is an area corresponding to the security processing and includes text and images which are securely printed, formatted, obscured, or omitted at a final output phase. The security area 13 may also be referred to as a restricted area or restricted data.

The scan data 10 which are shown in (a) in FIG. 2 becomes an image which is scanned by a copy command with respect to a printed document by the host apparatus 200 (to be described later). The image of the security area 13 is in a preset security color. The security color may include one of cyan (C), magenta (M), and yellow (Y), or a combination of at least two foregoing colors.

For example, when a user indicates via the second user input 230 that predetermined text, graphics, or a predetermined region of an electronic or physical document includes restricted or confidential information, the second controller 270 of the host apparatus 200 may control the formatting of the text, graphics, and images of the security area 13 to associate the text, graphics, and images with a predetermined color, such as cyan, magenta, and yellow. The controller 270 may associate the text, graphics, or images with the color by changing a font, highlight, fill, outline, or other characteristic of the text, graphics, images, or the entire security area 13. The color information and information about which characteristic(s) has been associated with the security color may be stored in the barcode 11 or other security code or symbol generated by the host apparatus 200 and included with the secure document associated with the scan data 10.

The first controller 170 may detect the additional information area 11 by searching a location corresponding to the bar code area of the scan data 10, such as a corner of the document, as illustrated in FIG. 2. Although FIG. 2 illustrates the bar code located in the upper right side of the document, the location of the bar code image is not limited thereto. The first controller 170 may extract the bar code image to scan the additional information.

The first controller 170 may adjust the extracted bar code image. The adjustment may include a pre-treatment process which is supplementary for an easier recognition of the bar code information.

More specifically, the first controller 170 may detect the bar code area 11 in a rectangular shape from the generated scan data and may extract the bar code image.

The first controller 170 adjusts the extracted bar code image for an easier recognition of the bar code. The first controller 170 may perform at least one of binarization, deskew, and a smoothing process on the extracted bar code image as an adjustment.

The first controller 170 may extract bar code character information from the adjusted bar code image and may decode the extracted character information to read the bar code information.

The extracted bar code character information may include digital data, such as 1's and 0's. The first controller 170 may decode the extracted character information with a predetermined algorithm. The decoding module for the decoding operation may correspond to an encoding module for the encoding operation and may be stored in advance in the first storage unit 150.

The first controller 170 reads the bar code information by using the extracted bar code character information. The read bar code information may include security color information applied to the image of the security area 13.

That is, the bar code according to the present general inventive concept may include only color information as the security information corresponding to the security area 13. Thus, the amount of information that must be generated by a host device and read and analyzed by an image forming apparatus is very small and any type of bar code may be used. There is little chance of errors in reading the bar code and an optional character recognition (OCR) is not needed. Only a simple processing may enable reading of the security information.

The additional information may include a predetermined mark including the color information of the security area 13 as well as the bar code.

The first controller 170 determines whether the scan data 10 include the color image by using the read bar code information. The bar code information may include data corresponding to a particular color, such as yellow, or the bar code may be generated in the particular security color.

If the scan data 10 include the image in the security color, the first controller 170 controls the image forming unit 120 to print the document excluding the security area 13 corresponding to the security color as in (b) in FIG. 2. That is, the image forming unit 120 does not perform an image forming process to the security area 13, and the printed scan data 10 may include only the general area 12 excluding the security area 13 as in (b) in FIG. 2.

If the image forming apparatus 100 includes a color printer, the scan data 10 is printed in color images excluding the security area 13. If the image forming apparatus 100 includes a mono printer, the scan data 10 are printed in black images excluding the security area 13.

If the image forming apparatus 100 includes a mono (black or grayscale) printer and the security color includes one of C, M, and Y, the first controller 170 may print only the black part of the scan data 10 without an additional security color removing process.

Accordingly, the image forming apparatus 100 according to the present general inventive concept may easily perform a security copy function by using a bar code including the security color information as the predetermined additional information and does not perform the image forming process to generate an image of the security area to thereby reduce processing and analysis requirements, which may in turn reduce printing or copying time, hardware requirements, and software requirements.

A user may print a document including predetermined additional information, such as a bar code, with the security color information, such as (a) in FIG. 2, by inputting text or image information included in the security area and security information including the security color information corresponding to the security area by using the host apparatus 200. The document which includes the security area and the predetermined additional information with respect to the security area may be generated by an application from at least one external device such as the host apparatus 200.

Referring to FIG. 1, the host apparatus 200 includes an image processor 220, a second user input unit 230, a second display unit 240, a second storage unit 250, a second communication unit 260 and a second controller 270.

The image processor 220 generates print data in a predetermined print language (e.g., GDI, PCL and PS) according to a print command through the second user input unit 230. The generated print data are transmitted to the image forming apparatus 100 through the second communication unit 260. The image forming apparatus 100 receives the print data from the host apparatus 200 and performs a print operation. The image processor 220 may include a printer driver which uses a predetermined print language.

More specifically, the image processor 220 generates binary data by performing rendering and halftoning processes with respect to the document by using the printer driver according to a user's print command, and converts the generated binary data into a bitmap image to be recognized by the image forming apparatus 100.

The image processor 220 may convert a text or image included in the security area 13 as a security target of the bitmap image according to the security information input through the second user input unit 230 into a predetermined security color.

For example, a user may select via the second user input unit 230 and the second display unit 240 physical dimensions of a document to be the security area 13, or a user may select individual or groups of text, graphics, and images to be the security area 13. Alternatively, the user may select specific words, phrases, or associated sentences or paragraphs and each selected word, phrase, or associated sentence or paragraph may be identified by the controller 270 as restricted data of a security area 13. The controller 270 may indicate to the image processor 220 which data is the restricted data or which data corresponds to the security area 13, and the image processor 220 may generate the additional information, such as the barcode, and may associate the data of the security area 13 with the color identified by the additional information.

For example, a user may select a particular text, e.g. “patent” as a security target. Likewise, a user may select a particular image, i.e., image 1 as a security target.

A user may select a predetermined color as a security color for the security target. The security color may be set as a default and stored in advance in the second storage unit 250.

The image processor 220 converts the text and image input by a user for security out of the generated bitmap images into a security color selected by a user.

The second user input unit 230 may include a keyboard and a mouse provided as an input device of the host apparatus 200, and a graphic user interface (GUI) (hereinafter, to be also called “UI”) which is generated by an execution of a printer driver or an additional application and displayed on the second display unit 240 to receive a user's input. The GUI according to the present general inventive concept includes an icon, a button, a text input window to be selected by a user.

A user may perform a log-in process to the image forming apparatus 100 through the second user input unit 230. A user may perform an administrator log-in process in which setting and change of all of the environments of the image forming apparatus 100 is available without an additional access limit.

To perform the administer log-in process, the second user input unit 230 receives an administrator ID and password from a user to log in the administrator mode. The second controller 270 certifies a user as a system administrator through the input administrator ID and password.

The second display unit 240 displays thereon a security information input screen.

More specifically, if a user inputs a print command, the second display unit 240 may display thereon a UI to select whether to print the predetermined additional information, e.g. a security document which is secured by the bar code.

If a user selects to print the security document corresponding to the displayed UI, the second display unit 240 displays a UI to input a secured text or image included in the security area 13 and a UI to select a security color for security. The UI may be displayed one at a time or simultaneously.

A user inputs text or image information corresponding to the security processing and security information including the security color information used for the security processing through the second user input unit 230 corresponding to the UI displayed on the second display unit 240.

The second display unit 240 may include an LCD and a driver (not shown) to drive the LCD.

The second storage unit 250 stores therein various print data for a print operation, scan data received from the image forming apparatus 100 through the second communication unit 260, various setting information through the second user input unit 230, user registration information set for each user account, user certification information, usage authorization information, etc.

The second storage unit 250 may further include an encoding module to encode the bar code included in print data. The encoding module corresponds to a decoding module to decode the bar code stored in the first storage unit 150.

The second storage unit 250 includes an internal storage medium such as an HDD, or an external or portable storage medium such as a USB memory, a memory card (memory stick, CF card, and a MMC), and a memory card slot.

The second communication unit 260 performs a data communication with the outside such as the image forming apparatus 100 connected in a wired/wireless network, and transmits print data in a predetermined print language to the image forming apparatus 100. The print data which are transmitted to the image forming apparatus 100 may include a bar code including security color information.

The second communication unit 260 may include a wired/wireless network communication module which is connected with an external device such as the image forming apparatus 100 by a local connection or in a network by a predetermined protocol, or an interface (e.g., USB port) connected to a portable storage medium such as a USB memory or an interface which is connected to the HDD

The second controller 270 controls the host apparatus 200 as a whole.

More specifically, the second controller 270 controls the image processor 220 to convert a target document into a bitmap image according to a print command, receives text or image information corresponding to the security processing and the security information including the security color information used for the security processing from the second user input unit 230, and controls the image processor 220 to search and convert a text or image from the bitmap image into a security color. The second controller 270 controls the image processor 220 to generate print data including a bar code or a mark by converting, i.e., encoding the input security color information as at least 1-D bar code or image.

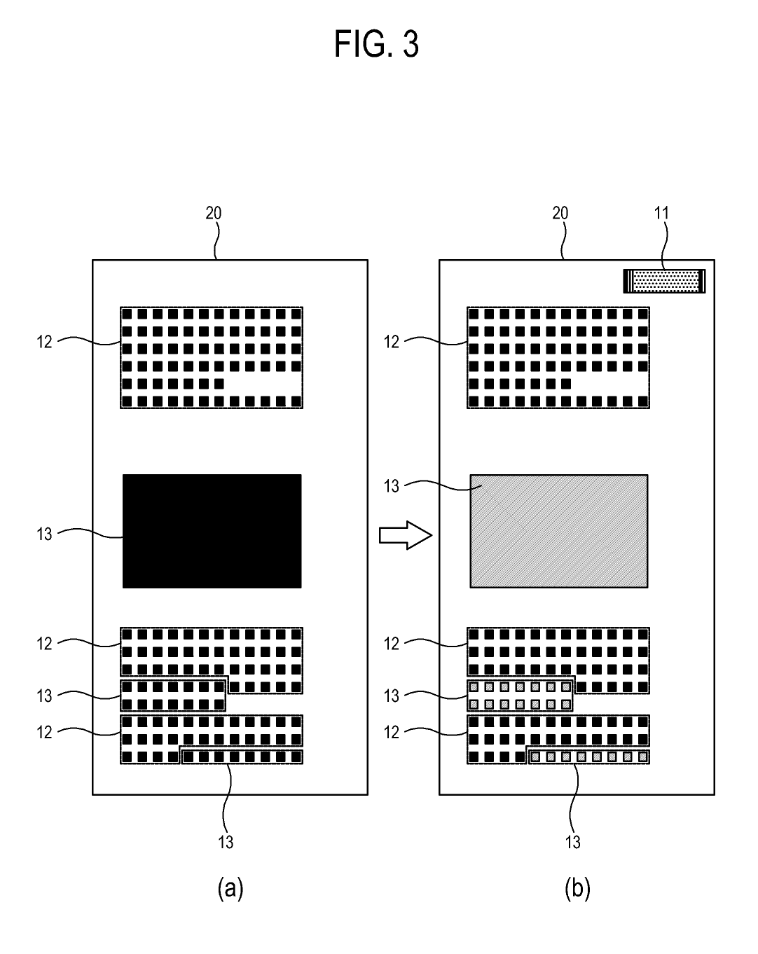

FIG. 3 illustrates bitmap images before and after a conversion of print data according to an exemplary embodiment of the present general inventive concept.

The second controller 270 may generate a bitmap image 20 as shown in (a) in FIG. 3 according to a user's print command.

The second controller 270 detects whether the bitmap image in (a) in FIG. 3 includes a text (e.g., patent) or an image (e.g., image 1) corresponding to the security processing input through the second user input unit 230. At least one text or image may be processed for security.

If the security area 13 including the text or image corresponding to the security processing is searched from the bitmap image in (a) in FIG. 3, the second controller 270 controls the image processor 220 to convert the searched security area 13 into a preset security color (e.g., one or combination of cyan, magenta and yellow) as in (b) in FIG. 3.

If the bitmap image in (a) in FIG. 3 includes the preset security color, the second controller 270 notifies a user of the foregoing. Then, a user may change the security color into a color which is not included in the bitmap image.

The controller 270 controls the image processor 220 to convert the security color information into a preset bar code or mark and generate print data including a bar code in a part (upper right side) as in (b) in FIG. 3.

The second controller 270 transmits the generated print data as in (b) in FIG. 3 to the image forming apparatus 100 through the second communication unit 260, and the image forming apparatus 100 prints the document including the bar code or mark as the preset additional information.

The image forming apparatus 100 prints the document including the preset additional information, excluding the preset security color, by reading the bar code of the scan data.

Accordingly, the host apparatus 200 according to the present general inventive concept may conveniently print the security document if a user selects the security information, i.e., text or image of the security area 13 or color information corresponding to the security area 13.

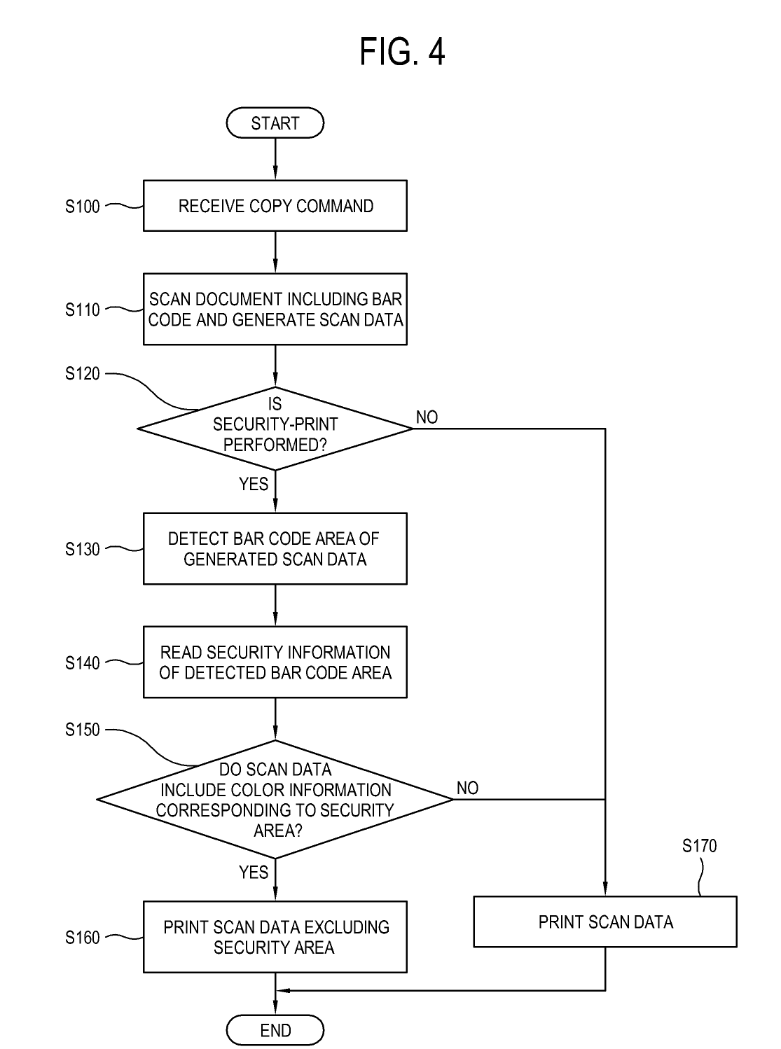

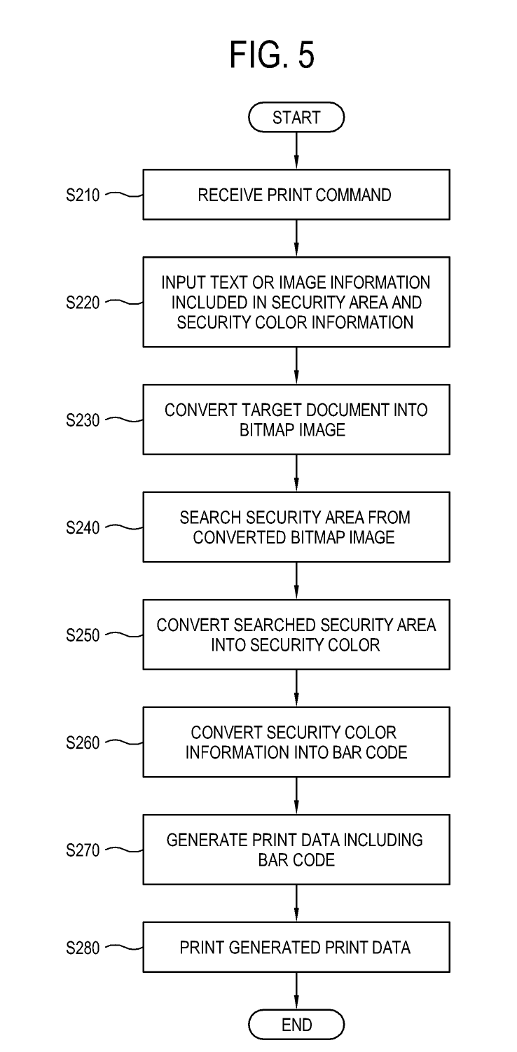

With the foregoing configuration, a security copy process of the image forming apparatus 100 and the host apparatus 200 will be described with reference to FIGS. 4 and 5.

FIG. 4 is a flowchart of a security copy process for a document which includes a security area according to an exemplary embodiment of the present general inventive concept.

As shown therein, the image forming apparatus 100 may receive a copy command from a user for a document including the predetermined additional information (S100). The predetermined additional information includes at least a 1-D bar code or mark as the additional information and includes the color information corresponding to the security area.

In operation S110, first controller 170 scans the document including the bar code and generates the scan data corresponding to the copy command at operation S100.

At operation S120, the first controller 170 may determine whether to security-copy the document by using the additional information of the scan data generated at operation S100, i.e. the bar code. If the additional information of the scan data includes the color information corresponding to the security area 13, the first controller 170 may determine that the print operation corresponding to the copy command at operation S100 is a security print operation. The color information may include at least one of cyan, magenta and yellow.

If it is determined as the copy print at operation S120, the first controller 170 detects the bar code area of the generated scan data and extracts the bar code image at operation S130. The first controller 170 may adjust the bar code image by performing at least one of binarization, deskew, and smoothing processes to the extracted bar code image.

At operation S140, the first controller 170 reads the additional information from the bar code image extracted at operation S130. The first controller 170 may extract the character information from the adjusted bar code image and read the bar code image by decoding the extracted character information.

At operation S150, the first controller 170 determines whether the scan data include the color information corresponding to the security area by using the bar code information, i.e., the additional information read at operation S140.

If it is determined at operation S150 that the scan data include the color information of the security area, the first controller 170 controls the image forming unit 120 at operation S160 to print the scan data excluding the security area from the scan data.

If it is determined at operation S150 that the scan data do not include the image of the security color, the first controller 170 controls the image forming unit 120 at operation S170 to print the scan data according to a general image forming process.

If it is determined at operation S120 that the print operation is not the security print operation, the first controller 170 controls the image forming unit 120 to print the scan data according to a general image forming process.

FIG. 5 is a flowchart of a process of generating a document including a security area according to an exemplary embodiment of the present general inventive concept.

At operation S210, the host apparatus 200 may receive a document print command from a user.

At operation S220, the second controller 270 may receive from a user the text or image information included in the security area of the document and the security information including the security color information used for the security processing through the second user input unit 230 according to the print command at operation S210.

At operation S230, the second controller 270 converts the document into a bitmap image corresponding to the print command at operation S210.

At operation S240, the second controller 270 searches the text or image of the security area input at operation S220 from the bitmap image converted at operation S230.

At operation S250, the second controller 270 converts the text or image of the security area searched at operation S240 into a security color input at operation S220.

At operation S260, the second controller 270 converts the security color information input at operation S220 into the predetermined additional information. The predetermined additional information may include at least a 1-D bar code or mark.

At operation S270, the second controller 270 generates the print data including the bitmap image converted at operation S250 and the bar code converted at operation S260. The generated print data are transmitted to the image forming apparatus 100 through the second communication unit 260.

At operation S280, the image forming apparatus 100 receives and prints the print data generated at operation S270. The printed document includes the bar code as the preset additional information including the color information corresponding to the security area.

Accordingly, the image forming apparatus 100 according to the present general inventive concept prints a document excluding an image in a preset security color by using the bar code or mark as the additional information including the security color information to thereby minimize the amount of the security information included in the bar code or mark and enables a simple print process.

Further, the host apparatus 200 according to the present general inventive concept converts a text or image corresponding to security information input by a user into a predetermined security color, and prints a document including a bar code or mark including security color information and generates a security document conveniently.

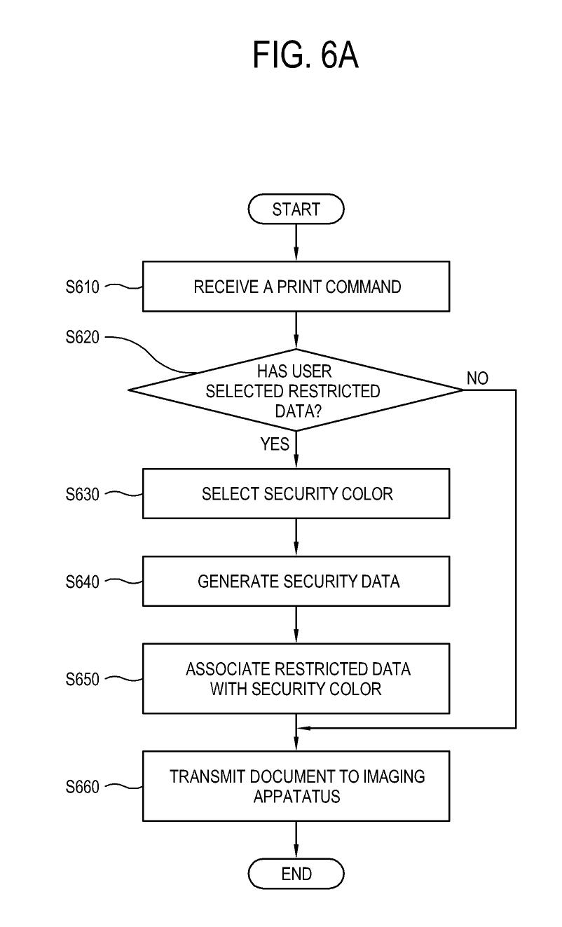

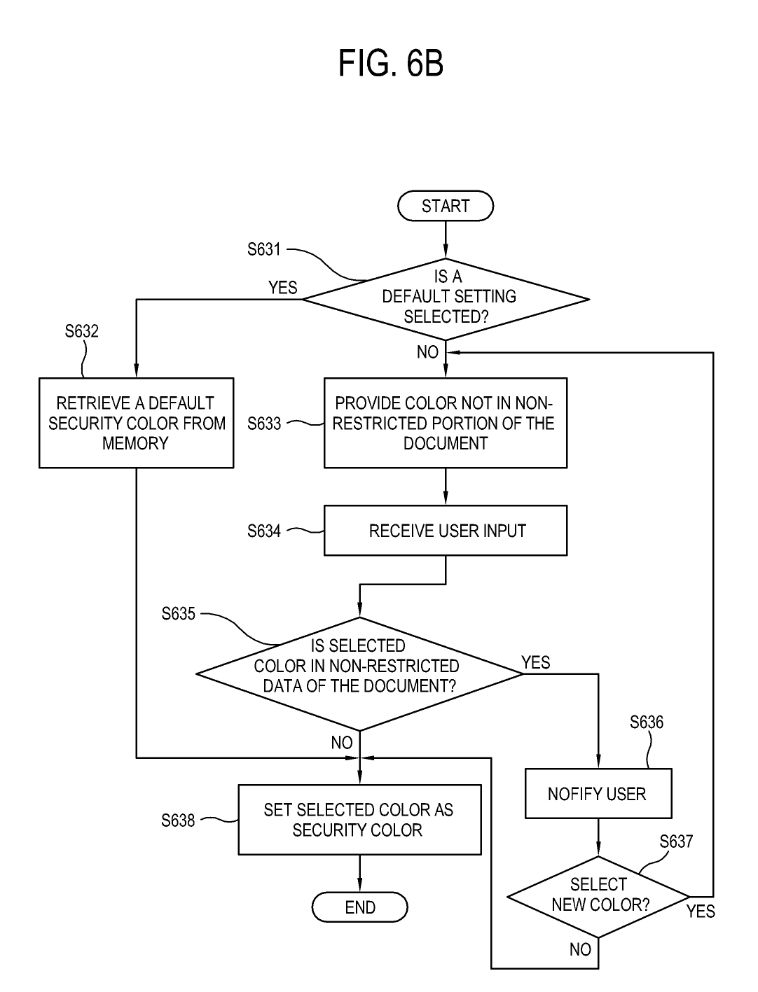

FIGS. 6A and 6B illustrate a method of printing a secure document according to another embodiment of the present general inventive concept. The method of printing the document may be applied to a document created by the user requesting a print operation or by another user viewing the pre-generated document.

In operation S610, a host device such as a personal computer, portable computing device, or other computing device capable of receiving user commands receives a command to print a document. In operation S620, the host device determines whether the user has indicated that there is secure information in the document. For example, a user may select text, graphics, or images during generation of a document. Alternatively, upon receipt of a print command, the host device may generate a prompt to receive a user input from a user to indicate if portions of the document are restricted or secure.

If it is determined that there is no restricted data in the document, the host device may print the document in operation S660. However, if it is determined that the document includes restricted data, the host device may select a security color in operation S630.

A process of selecting a security color according to an embodiment of the present general inventive concept is illustrated in FIG. 6B. In operation S631, the host device may determine whether a default security color setting exists. For example, a predetermined security color or plurality of possible security colors may be stored in a storage unit or memory device of the host device. If a plurality of potential security colors are stored, the host apparatus may select a default security color in operation S632 that does not already exist in the document, so only the restricted data will be adjusted or omitted in a printing operation.

If it is determined in operation S631 that a default security color setting does not exist or is not selected, the host device may provide a prompt to a user to select a security color. For example, the host may supply a user with a plurality of potential colors that do not already exist in the document.

In operation S634, the host may receive a user input indicating the selected security color. In operation S635, the host device may determine whether the security color selected by the user already exists in the document. If the color already exists, the host may notify the user in operation S636 and may give the user the option to select another color in operation S637.

If it is determined in operation S635 that the selected color does not already exist in the document or if the user indicates in response to operation S637 that the user wishes to use a color that already exists in the document, the host may set the selected color as the security color.

Referring back to FIG. 6A, upon selecting the security color, the host may generate security information in operation S640. The security information may be in the form of a barcode formed on the document, for example, and may include instructions for an image forming apparatus as to an operation to perform when a text, graphic, or image is encountered that includes the security color. For example, the security information may be a yellow barcode that includes instructions to the image forming apparatus to not print yellow text, graphics, or images.

In operation S650, the host may associate data that is to be restricted or confidential with the security color. For example, the host may change a text font to a yellow color, or may set the line color and fill of an image to a yellow color.

Upon setting the security color, generating the security information, and associating restricted data with the security color, the host may transmit the document to an image forming apparatus in operation S660 to be printed.

Although various operations have been described with respect to FIGS. 6A and 6B, a method of printing a document may be performed by performing the operations in a different order than that described above. For example, after a security color is selected, the restricted data may be associated with the security color then the security information may be generated.

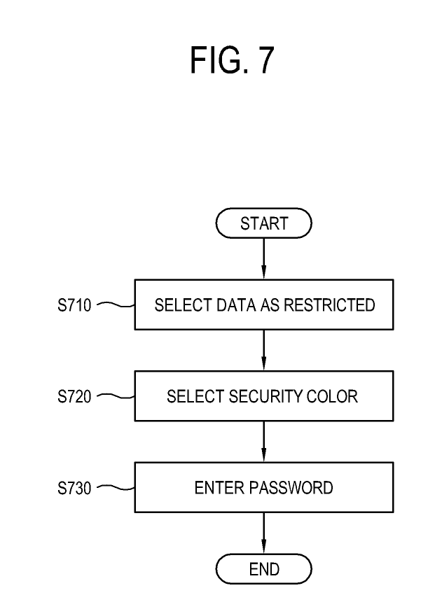

FIG. 7 illustrates a user operation to select security information. In operation S710, a user selects data in a document to be restricted. For example, a user may highlight text or an image and may select an icon located on a display or enter a command in a computing device to indicate that the selected data or image is restricted. The user selection may occur as the document is generated or may occur when a user indicates that the document is to be printed. For example, a computing device may generate a prompt to select restricted data when a user executes a print operation.

Selection of the restricted data or image may occur by selecting a geographic area of a document, such as by performing a dragging motion of a mouse on a display to select a particular area of a document displayed on the display. Alternatively, the selection may occur by selecting text, images, or other data with a cursor on the display. Alternatively, the selection may occur automatically according to predetermined terms. For example, a user may indicate that each paragraph that includes the word “patent” is restricted, and the computing device may then automatically select each such paragraph without further user input, or with a prompt to allow the user to approve each paragraph.

In operation S720, a user may select a security color. As discussed above, a user may select any security color that exists in the document or that does not exist in the document already, a user may set default security colors, or default colors may be pre-set and automatically applied to the document. A security color may be selected so that the restricted data is visible on a screen. For example, a dark security color may be selected that is similar to black to generate a strong contrast when the color is displayed on a screen. On the other hand, according to the security information generated by a host device, the restricted data may be omitted from, or adjusted in, a printed document.

In operation S730, the computing device may prompt the user to enter a password. For example, the user may wish for only predetermined users or users that have the password to be able to print or copy data.

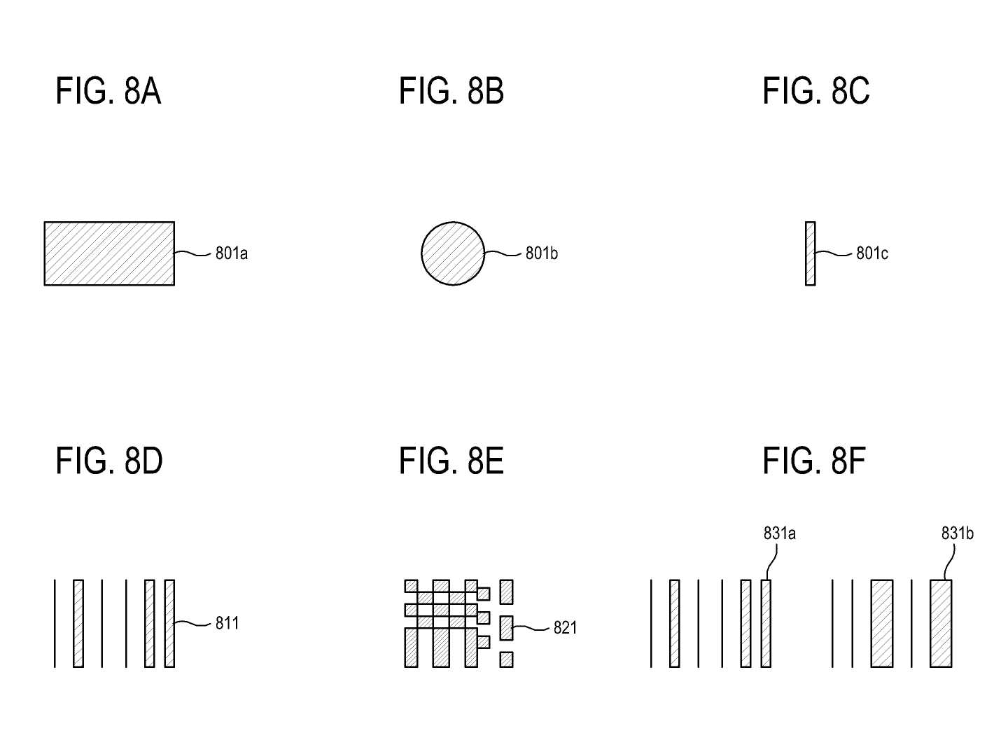

FIGS. 8A-8F illustrate examples of security information according to embodiments of the present general inventive concept.

As illustrated in FIGS. 8A-8C, security data 801a, 801b, and 801c may be as simple as a mark of a predetermined color at a predetermined location on a document. An image-forming apparatus may be pre-programmed to search the pre-determined location of the document for the mark 801a, 801b, or 801c. If the image forming apparatus encounters the mark, 801a, 801b, or 801c, the image forming apparatus may perform a certain function, such as omitting data, when data of the predetermined color is encountered in the document that includes the mark 801a, 801b, or 801c. The mark 801a, 801b, or 801c may include no other information, and may be a box 801a, a circle 801b, a line 801c, or any other shape. According to one embodiment, the mark 801 may be of any color, and when the image forming apparatus detects the mark 801, the image forming apparatus may perform the predetermined operation on the data in the document that corresponds with a pre-stored color that may be different than the color of the mark. In other words, the presence of the mark 801 may initiate a pre-stored operation on data of a pre-stored color in a document.

FIG. 8D illustrates a 1-D barcode 811 as the security data. The barcode may be read linearly (1-D) and may include data such as an operation to be performed and a color upon which the operation should be performed. The barcode, itself, may be of the security color, or the lines and spaces of the barcode may represent data to indicate to an image forming apparatus the security color.

FIG. 8E illustrates a 2-D barcode 821 as the security data. The 2-d barcode may include shapes and spaces of varying sizes and dimensions to represent data. Similar to the 1-D barcode 811, the 2-D barcode 821 may include data indicating the security color and an operation to be performed on data of the security color, or the barcode 821 may be formed of the security color.

FIG. 8F illustrates two 1-D barcodes 831a and 831b located on a same document. Each barcode 831a and 831b may include different instructions and may be associated with a different security color. For example, the barcodes 831a and 831b may correspond to different users, different imaging operations, such as copying, printing, and scanning, or different operations such as blocking out, and omitting.

According to one example embodiment, a barcode or a plurality of barcodes may perform omit a first block of text when a first user copies or prints the document and omits a second block of text when a second user copies or prints the document. The first and second blocks of text may be associated with different security colors.

As described above, an image forming apparatus, a host apparatus and a print method thereof according to the present general inventive concept prints a document excluding an image in a security color by using preset additional information including security color information to thereby minimize the amount of security information included in the additional information and provides a simple print process.

Also, an image forming apparatus, a host apparatus and a print method thereof according to the present general inventive concept converts a text or image corresponding to security information input by a user into a predetermined security color and prints a document including additional information including security color information and generate a security document conveniently.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A security copy method of an image forming apparatus which is connected to at least one external device and comprises an image scanner to scan a document comprising a security area, the method comprising:
generating scan data by scanning the document comprising predetermined additional information;
determining whether to security-print the document by using the additional information of the generated scan data;
determining whether the scan data comprise color information corresponding to the security area; and
printing the scan data excluding a security area corresponding to the color information from the scan data according to the determination result, wherein
the color information includes at least one of, or a combination of, cyan (C), magenta (M), and yellow (Y).

2. The method according to claim 1, wherein the predetermined additional information comprises at least a 1-D bar code or mark.

3. The method according to claim 1, further comprising generating a document comprising the predetermined additional information, wherein
the additional information comprises color information corresponding to the security area.

4. The method according to claim 3, wherein the generating the document comprises generating the document by using an application from at least one external device.

5. The method according to claim 2, wherein the determining whether to security-print the document comprises detecting a bar code or mark area of the generated scan data; and
reading the detected bar code or mark area information and determining whether the read bar code or mark information comprises color information corresponding to the security area.

6. The method according to claim 1, further comprising receiving a copy command with respect to the document comprising the predetermined additional information.

7. The method according to claim 1, further comprising inputting text or image information comprised in the security area and security color information corresponding to the security area.

8. The method according to claim 7, further comprising converting a target document into a bitmap image according to a print command; and
searching a text or image comprised in the security area from the converted bitmap image and converting the text or image into the security color.

9. The method according to claim 7, further comprising converting the input security color information into at least a 1-D bar code or mark.

10. An image forming apparatus which performs a security copy function by using a security color of a document, the image forming apparatus comprising:
an image forming unit which performs a print operation;
an image scanner which scans a document comprising a security area; and
a controller to control the image scanner to scan the document comprising predetermined additional information and to generate scan data, to determine whether to security-print the document by using additional information of the generated scan data, to determine whether the scan data comprise security information corresponding to the security area, and to control the image forming unit to print the scan data excluding a security area corresponding to the color information from the scan data according to the determination result,
wherein the color information includes at least one of, or a combination of, cyan (C), magenta (M) and yellow (Y).

11. The image forming apparatus according to claim 10, wherein the predetermined additional information comprises at least a 1-D bar code or mark.

12. The image forming apparatus according to claim 11, wherein the controller detects a bar code or mark area of the generated scan data and reads the detected bar code or mark area and determines whether the read bar code or mark information comprises color information corresponding to the security area.

13. The image forming apparatus according to claim 10, further comprising a user input unit which receives a copy command with respect to a document comprising the predetermined additional information.

14. A host apparatus which is connected to at least one image forming apparatus and generates print data comprising security color information, the host apparatus comprising:
a communication unit which communicates with the image forming apparatus;
an image processor which generates print data comprising a security area;
a user input unit which receives text or image information comprised in the security area and security color information corresponding to the security area; and
a controller which controls the image processor to generate print data comprising at least a 1-D bar code or mark corresponding to the input security color information and controls the communication unit to transmit the generated print data to the image forming apparatus.

15. The host apparatus according to claim 14, wherein the user input unit receives a print command, and
the controller controls the image processor to convert a target document into a bitmap image according to the print command and search a text or image comprised in the security area from the converted bitmap image and generate print data converted into the security color.

16. The host apparatus according to claim 15, wherein the controller controls the image processor to convert the input security color information into at least a 1-D bar code or mark.

17. A method of generating a secure document, the method comprising:
receiving an input to select first data of a document as restricted data;
associating the first data with a security color;
generating a security code on the document to include the security color; and
transmitting the document including the security code to an image forming apparatus.

18. The method according to claim 17, wherein receiving an input to select the first data includes receiving an instruction to select each data anywhere in the document having a predetermined characteristic as restricted data.

19. The method according to claim 17, wherein associating the first data with the security color includes determining whether a first color is located in non-restricted data of the document; and
if the first color is not located in the non-restricted data of the document, selecting the first color as a security color, and if the first color is located in the non-restricted data of the documents, selecting a second color different from the first color as the security color.

20. The method according to claim 17, further comprising providing the user with at least one suggested color to select that is not located in non-restricted data of the document.

21. The method according to claim 17, wherein generating the security code on the document includes generating a barcode,
wherein the barcode includes data regarding at least one of an operation to perform on the restricted data, a user to be allowed to perform an imaging operation to image the restricted data, and an imaging operation to reproduce the restricted data.

22. A method of copying a document including restricted data in an image copying apparatus, the method comprising:
determining whether restricted data exists in the document;
identifying the restricted data in the document by detecting a security color associated with the restricted data; and
performing a security operation on the restricted data when copying the document,
wherein determining whether the restricted data exists includes detecting security data on the document, and
wherein the security data includes a barcode.

23. A electronic document generating apparatus, comprising:
a user input unit to receive an input to select first data in an electronic document as restricted data;
an image processor to associate the restricted data in the electronic document with a security color and to generate security data in the document to instruct an imaging apparatus to perform a predetermined security operation on the restricted data indicated by the security color; and
a storage unit to store at least one predetermined security color,
wherein the security data includes a barcode, and
the image processor processes each of the barcode and the restricted data to be formatted in the security color.

24. An image forming apparatus, comprising:
a scanning unit to scan a document;
an image forming unit to form an image of the document onto a recording medium; and
a controller to detect whether the document includes restricted data and to control the image forming unit to perform a security operation on the restricted data,
wherein the restricted data is detected by detecting a security color, and
wherein the controller detects whether security data exists on the document by controlling the scanning unit to search for the security data at a predetermined location on the document.
